(19) United States
(12) Patent Application Publication
(10) Pub. No.: US 2018/0328215 A1
(43) Pub. Date: Nov. 15, 2018

(54) METHOD AND DEVICE FOR CONTROLLING BLADE OUTER AIR SEALS

(71) Applicant: United Technologies Corporation, Farmington, CT (US)

(72) Inventors: Peter L. Jalbert, Granby, CT (US); William E. Rhoden, Glastonbury, CT (US)

(21) Appl. No.: 15/109,188

(22) PCT Filed: Dec. 19, 2014
(86) PCT No.: PCT/US14/71598

§ 371 Date: Jun. 30, 2016

Related U.S. Application Data
(60) Provisional application No. 61/922,355, filed on Dec. 31, 2013.

(51) Int. Cl. F01D 11/22; F01D 21/00

(52) U.S. Cl. CPC F01D 11/22; F01D 21/003; F05D 2260/57; F05D 2240/11; F05D 2270/20; F05D 2270/54

(57) ABSTRACT

A device and methods are provided for controlling blade outer air seal of a gas turbine engine. In one embodiment, a method includes receivg blade outer air seal clearance from an integrated sensor actuator, determining blade outer seal control by an electronic engine control unit, and controlling the blade outer air seal clearance by the electronic engine control unit, wherein an interleaved blade outer air seal is positioned by an integrated sensor actuator.

### CROSS-REFERENCE TO RELATED APPLICATIONS

This application claims priority to U.S. Provisional Application No. 61/922,355 filed on Dec. 31, 2013 and titled Method and Device for Controlling Blade Outer Air Seal, the disclosure of which is hereby incorporated by reference in its entirety.

### FIELD

The present disclosure relates generally to gas turbine engines, and more particularly to methods and devices for controlling gas turbine engine case clearance.

### BACKGROUND

Turbine engines generally include fan, compressor, combustor and turbine sections positioned along an axial centerline. Each rotor assembly typically includes a plurality of blades extending out relative to the axial centerline. An outer case, including blade outer air seals (BOAS) can provide a radial surface along the flow path of the engine. Current clearance control systems in turbine engines use cooling air on the turbine case to control clearance for a case and blades. Conventional systems are slow acting and conservative because blade to outer seal rubs are bad for the engine. Advanced Clearance Control Systems are under investigation at engine manufacturer's facilities that use faster acting actuators and advanced sensor systems to give more control over the blade to seal clearance. Systems are large and bulky, containing so many sensors and actuators that benefits are not readily apparent.

There is a desire to provide a clearance control system that overcomes one or more of the aforementioned drawbacks.

### BRIEF SUMMARY OF THE EMBODIMENTS

Disclosed and claimed herein are a methods and devices for controlling blade outer air seal clearance. In one embodiment, a method for controlling blade outer air seal clearance includes receiving blade outer air seal clearance from an integrated sensor actuator, determining blade outer seal control by an electronic engine control unit, and controlling the blade outer air seal clearance by the electronic engine control unit, wherein an interleaved blade outer air seal is positioned by an integrated sensor actuator.

According to another embodiment, an integrated sensor actuator is provided for blade outer air seals. In one embodiment, the integrated sensor actuator includes an actuator, a sensor configured to detect blade outer air seal clearance, and a control unit configured to control blade outer air seal clearance for at least a portion of the blade outer air seal, wherein the blade outer air seal is positioned by integrated sensor actuators.

According to another embodiment, a blade outer air seal control system includes a plurality of integrated sensor actuators, segmented blade outer air seals, and a control unit. In one embodiment, the control unit is configured to receive blade outer air seal clearance from plurality of integrated sensor actuators, determine blade outer seal control by an electronic engine control unit, and control the blade outer air seal clearance by the electronic engine control unit, wherein interleaved blade out seals are positioned by integrated sensor actuators.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified system diagram according to one or more embodiments;

FIG. 2 depicts a method for controlling blade outer air seals according to one or more embodiments; and

FIG. 3 depicts a graphical representation of an integrated sensor actuator.

### DETAILED DESCRIPTION OF THE EXEMPLARY EMBODIMENTS

### Overview and Terminology

One aspect of the disclosure relates to control of blade outer air seal (BAOS), such as an interleaved blade outer air seal or quadrant blade outer air seal. According to one embodiment, a system, methods and device are provided to control a segmented blade outer air seal (BOAS) that is movable by one or more actuators. According to one embodiment, integrated sensor actuators may be employed to position a blade outer air seal quadrant. In this case, a linear actuator is used to press the blade outer air seal radially toward the center of the engine. According to another embodiment, the blade outer air seal may be interleaved to decrease the circumference of the casing. As such, the distance between the nearest rotating blade and the BOAS may be decreased. Individual quadrant control allows the system to compensate for variances in clearances at points around the circumference.

According to another embodiment, a gas turbine engine is provided including an engine control unit configured to control an engine based on blade clearance.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

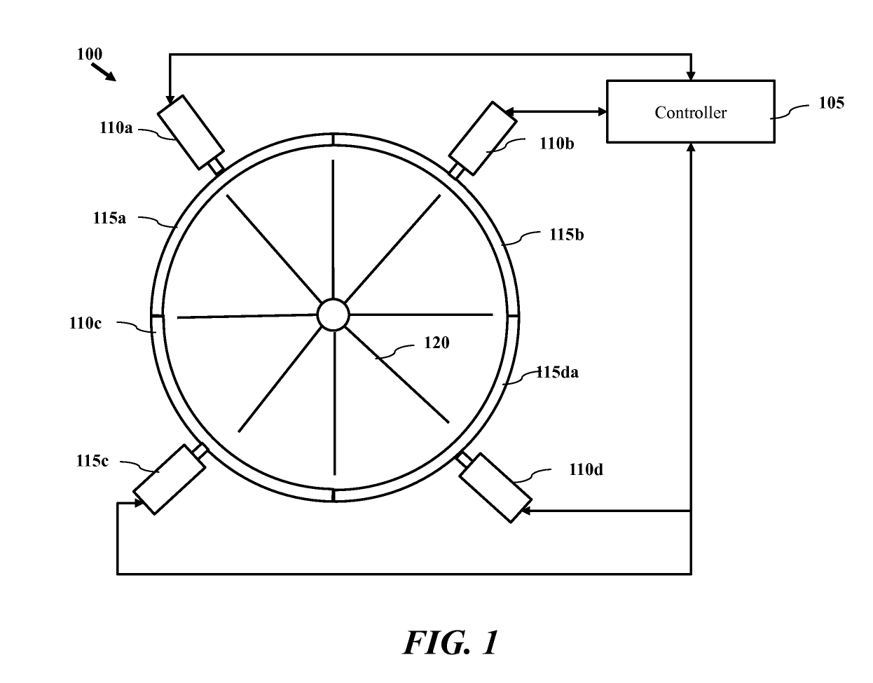

Referring now to the figures, FIG. 1 depicts a simplified blade outer air seal (BAOS) system diagram according to one or more embodiments. Blade outer air seal control system 100 includes controller 105, integrated sensor actuators 110a-110d and segmented blade outer seal elements 115a-115d. According to one embodiment, controller 105 which may be a control unit, may be configured to receive blade outer air seal clearance from integrated sensor actuators 110a-110d, determine blade outer seal control, and control the blade outer air seal clearance. Segmented blade outer seal elements 115a-115d may be interleaved blade outer seals positioned by integrated sensor actuators 110a-110d. Blade outer seal elements 115a-115d may be segmented to include four quadrants. For purposes of illustration rotor blades are shown as 120 (e.g., compressor blades, etc.).

Integrated sensor actuators 110a-110d may each be configured to position (e.g, press and pull) one of the interleaved blade outer air seal elements 115a-115d. The actuator

Integrated sensor actuators 110a-110d may be one or more of a ball and screw, piezoelectric actuator, hydraulic actuator and actuator in general. Integrated sensor actuators 110a-110d may be configured to determine the blade outer air seal clearance, which may be the distance from a rotor element to a segment of a blade outer air seal. Each sensor may be configured to determine the nearest distance of a rotating blade to at least a portion of the blade outer air seal. Controller 105 may be configured to receive clearance data from each of integrated sensor actuators 110a-110d. Controller 105 may also control actuators of integrated sensor actuators 110a-110d to set clearance distances of one or more blade outer air seal elements 115a-115d. The blade outer air seal elements 115a-115d may be pushed to cause overlap at segment joints and to decreasing clearance gap.

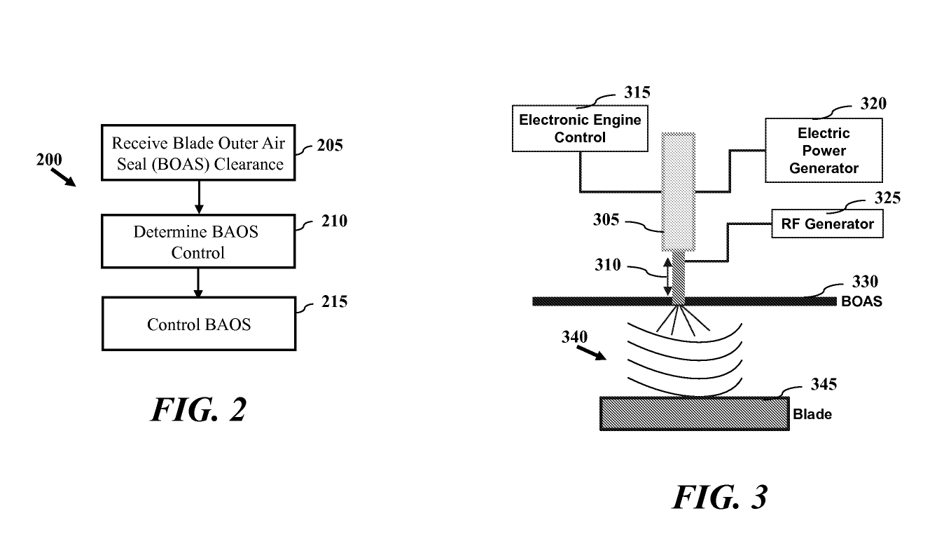

FIG. 2 depicts a method for controlling blade outer air seal clearance according to one or more embodiments. Process 200 may be initiated by receiving blade outer air seal clearance from an integrated sensor actuator at block 205. The blade outer seal clearance may relate to a distance from a rotor element to a segment of a blade out air seal. Receiving blade outer air seal clearance can include receiving clearance data from four integrated sensor actuators.

At block 210, the control of the blade outer seal may be determined by an electronic engine control unit. Determining blade outer air seal control may include determining the nearest distance of a rotating blade to at least a portion of the blade outer air seal. The blade outer air seal component may be a segmented seal having four quadrants.

At block 215, the blade outer air seal clearance may be controlled by the electronic engine control unit. According to one embodiment, an interleaved blade outer air seal is positioned by an integrated sensor actuator at block 215. Controlling at block 215 may include outputting one or more control signals to control position of one or more integrated sensor actuators to position one or more blade outer air seal components.

FIG. 3 depicts a graphical representation of an integrated sensor actuator according to one or more embodiments. According to one embodiment, integrated sensor actuator 305 for blade outer air seals may include an actuator, a sensor configured to detect blade outer air seal clearance, and a control unit configured to control blade outer air seal clearance for at least a portion of the blade outer air seal. Integrated sensor actuator 305 may position a blade outer air seal. Integrated sensor actuator 305 may position by pushing or pulling the blade outer air seal 330 as shown by 310 in FIG. 3. The actuator of integrated sensor actuator 305 may be one or more of a ball and screw, piezoelectric actuator, hydraulic actuator and actuator in general.

According to one embodiment, integrated sensor actuator 305 may be coupled to an Electronic Engine control unit 315, Electric power generator 320, and RF generator 325. Integrated sensor actuator 305 may be configured to output clearance data to Electronic Engine Control unit 315, such as the nearest distance of a rotating blade to at least a portion of the blade outer air seal. Electronic Engine Control unit 315 may be configured to putput control data to integrated sensor actuator 305 to set clearance of a blade outer air seal. RF generator 325 may be employed to control an actuator of integrated sensor actuator 305. The actuator of integrated sensor actuator 305 may be coupled to blade outer air seal 330 in order to control clearance 340 between blade out air seal 330 and blade 345.

While this disclosure has been particularly shown and described with references to exemplary embodiments thereof, it will be understood by those skilled in the art that various changes in form and details may be made therein without departing from the scope of the claimed embodiments.

What is claimed is:

1. A method for controlling blade outer air seal clearance, the method comprising the acts of:
receiving blade outer air seal clearance from an integrated sensor actuator;
determining blade outer seal control by an electronic engine control unit; and
controlling the blade outer air seal clearance by the electronic engine control unit, wherein an interleaved blade outer air seal is positioned by an integrated sensor actuator.

2. The method of claim 1, wherein the blade outer seal clearance is a distance from a rotor element to a segment of a blade out air seal.

3. The method of claim 1, wherein receiving blade outer air seal clearance includes receiving clearance data from four sensors integrated sensor actuators.

4. The method of claim 1, wherein determining blade outer air seal control includes determining the nearest distance of a rotating blade to at least a portion of the blade outer air seal.

5. The method of claim 1, wherein controlling includes outputting one or more control signals to control position of one or more integrated sensor actuators to position one or more blade outer air seal components.

6. The method of claim 1, wherein the blade outer air seal component is a segmented seal having four quadrants.

7. An integrated sensor actuator for blade outer air seals comprising:
an actuator;
a sensor configured to detect blade outer air seal clearance; and
a control unit configured to control blade outer air seal clearance for at least a portion of the blade outer air seal, wherein the blade outer air seal is positioned by integrated sensor actuators.

8. The integrated sensor actuator of claim 7, wherein the actuator is one or more of a ball and screw, piezoelectric actuator, hydraulic actuator and actuator in general.

9. The integrated sensor actuator of claim 7, wherein the blade outer air seal clearance is a distance from a rotor element to a segment of a blade outer air seal.

10. The integrated sensor actuator of claim 7, wherein the control unit is configured to receive clearance data from four integrated sensor actuators.

11. The integrated sensor actuator of claim 7, wherein the sensor is configured to determine the nearest distance of a rotating blade to at least a portion of the blade outer air seal.

12. The integrated sensor actuator of claim 7, wherein the blade outer air seal component is a segmented seal having four quadrants.

13. A blade outer air seal control system comprising:
a plurality of integrated sensor actuators;
segmented blade outer air seals; and
a control unit configured to
receive blade outer air seal clearance from plurality of integrated sensor actuators;
determine blade outer seal control by an electronic engine control unit; and
control the blade outer air seal clearance by the electronic engine control unit, wherein interleaved blade out seals are positioned by integrated sensor actuators.

14. The system of claim 13, wherein the actuator is one or more of a ball and screw, piezoelectric actuator, hydraulic actuator and actuator in general.

15. The system of claim 13, wherein the blade outer air seal clearance is a distance from a rotor element to a segment of a blade outer air seal.

16. The system of claim 13, wherein the control unit is configured to receive clearance data from four integrated sensor actuators.

17. The system of claim 13, wherein the sensor is configured to determine the nearest distance of a rotating blade to at least a portion of the blade outer air seal.

18. The system of claim 13, wherein the blade outer air seal component is a segmented seal having four quadrants.
